(19) United States
(12) Patent Application Publication
(10) Pub. No.: US 2024/0259343 A1
(43) Pub. Date: Aug. 1, 2024

(54) APPARATUS, METHOD, AND COMPUTER PROGRAM

(71) Applicant: Nokia Technologies Oy, Espoo (FI)

(72) Inventors: Péter FAZEKAS, Budapest (HU); Ákos LEITER, Budapest (HU)

(21) Appl. No.: 18/421,297

(22) Filed: Jan. 24, 2024

(30) Foreign Application Priority Data
Jan. 27, 2023 (GB) 2301163.8

(51) Int. Cl. H04L 61/5007; H04W 72/231

(52) U.S. Cl. CPC H04L 61/5007; H04W 72/231

(57) ABSTRACT

There is provided a method, apparatus, and computer program for causing a user equipment to perform: identifying a first identifier that uniquely identifies the user equipment; and generating a first internet protocol, IP, address for addressing the user equipment using at least part of the first identifier, the first IP address being for direct non-access stratum signalling between the user equipment and a network function of a core network.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by the 3rd Generation Partnership Project (3GPP), satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards. 3GPP has issued a number of releases (Rel) for defining operating communication protocols related to a communications network. Currently, objectives and work are being set in relation to Release 18 (Rel. 18).

### SUMMARY

According to a first aspect, there is provided a method for a user equipment, the method comprising: identifying a first identifier that uniquely identifies the user equipment; and generating a first internet protocol, IP, address for addressing the user equipment using at least part of the first identifier, the first IP address being for direct non-access stratum signalling between the user equipment and a network function of a core network.

The method may comprise, subsequent to said generating, initiating direct non-access stratum signalling the network function using the first IP address.

The method may comprise receiving, from a radio access network node, a radio resource control configuration comprising a second IP address, the second IP address identifying a repository function of the core network.

The method may comprise: signalling the repository function using the second IP address to request a third IP address that identifies the network function; and receiving the third IP address from the repository function.

The method may comprise directly signalling the network function using non-access stratum signalling that comprises the third IP address.

The signalling the repository function may comprise signalling the repository function using radio resource control signalling.

The generating may comprise: forming a first part of the first IP address using information received from a radio access network node, the first part comprising a routable part of the first IP address; and forming a second part of the first IP address that uniquely identifies the user equipment.

The forming the second part of the first IP address may comprise: concatenating at least part of a temporary identifier of the user equipment or a random value with a random value to form a concatenated value; and generating the first IP address from the concatenated value.

The forming the first part of the first IP address may comprise: receiving, from the radio access network node, a network identifier value and a network mask that indicates a length of the first part; and forming the first part by applying the network mask to the network identifier value.

The network identifier value and the network mask may be received via radio resource control configuration signalling.

According to a second aspect, there is provided a method for a radio access network node, the method comprising: signalling, to a user equipment, information for generating a first part of an internet protocol, IP, address for identifying the user equipment for direct non-access stratum signalling between the user equipment and a network function of a core network.

The information may comprise a network identifier value and a network mask that indicates a length of the first part.

The signalling may be comprised in radio resource control configuration signalling.

The method may comprise signalling, to the user equipment in radio resource control configuration signalling, a second IP address, the second IP address identifying a repository function of the core network.

The method may comprise receiving, from the user equipment, an indication of a value used by the user equipment for generating a second part of the first IP address.

The method may comprise: receiving, from the user equipment, non-access stratum signalling for the network function comprised in the core network, the non-access stratum signalling comprising the first IP address; and forwarding the non-access stratum signalling to the network function.

According to a third aspect, there is provided an apparatus for a user equipment, the apparatus comprising means for performing: identifying a first identifier that uniquely identifies the user equipment; and generating a first internet protocol, IP, address for addressing the user equipment using at least part of the first identifier, the first IP address being for direct non-access stratum signalling between the user equipment and a network function of a core network.

The apparatus may comprise means for performing, subsequent to said generating, initiating direct non-access stratum signalling the network function using the first IP address.

The apparatus may comprise means for performing receiving, from a radio access network node, a radio resource control configuration comprising a second IP address, the second IP address identifying a repository function of the core network.

The apparatus may comprise means for performing: signalling the repository function using the second IP address to request a third IP address that identifies the network function; and receiving the third IP address from the repository function.

The apparatus may comprise means for performing directly signalling the network function using non-access stratum signalling that comprises the third IP address.

The signalling the repository function may comprise signalling the repository function using radio resource control signalling.

The generating may comprise: forming a first part of the first IP address using information received from a radio access network node, the first part comprising a routable part of the first IP address; and forming a second part of the first IP address that uniquely identifies the user equipment.

The forming the second part of the first IP address may comprise: concatenating at least part of a temporary identifier of the user equipment or a random value with a random value to form a concatenated value; and generating the first IP address from the concatenated value.

The forming the first part of the first IP address may comprise: receiving, from the radio access network node, a network identifier value and a network mask that indicates a length of the first part; and forming the first part by applying the network mask to the network identifier value.

The network identifier value and the network mask may be received via radio resource control configuration signalling.

According to a fourth aspect, there is provided an apparatus for a radio access network node, the apparatus comprising means for performing: signalling, to a user equipment, information for generating a first part of an internet protocol, IP, address for identifying the user equipment for direct non-access stratum signalling between the user equipment and a network function of a core network.

The information may comprise a network identifier value and a network mask that indicates a length of the first part.

The signalling may be comprised in radio resource control configuration signalling.

The apparatus may comprise means for performing signalling, to the user equipment in radio resource control configuration signalling, a second IP address, the second IP address identifying a repository function of the core network.

The apparatus may comprise means for performing receiving, from the user equipment, an indication of a value used by the user equipment for generating a second part of the first IP address.

The apparatus may comprise means for performing: receiving, from the user equipment, non-access stratum signalling for the network function comprised in the core network, the non-access stratum signalling comprising the first IP address; and forwarding the non-access stratum signalling to the network function.

According to a fifth aspect, there is provided an apparatus for a user equipment, the apparatus comprising: at least one processor; and at least one memory comprising code that, when executed by the at least one processor, causes the apparatus to perform: identifying a first identifier that uniquely identifies the user equipment; and generating a first internet protocol, IP, address for addressing the user equipment using at least part of the first identifier, the first IP address being for direct non-access stratum signalling between the user equipment and a network function of a core network.

The apparatus may be caused to perform, subsequent to said generating, initiating direct non-access stratum signalling the network function using the first IP address.

The apparatus may be caused to perform receiving, from a radio access network node, a radio resource control configuration comprising a second IP address, the second IP address identifying a repository function of the core network.

The apparatus may be caused to perform: signalling the repository function using the second IP address to request a third IP address that identifies the network function; and receiving the third IP address from the repository function.

The apparatus may be caused to perform directly signalling the network function using non-access stratum signalling that comprises the third IP address.

The signalling the repository function may comprise signalling the repository function using radio resource control signalling.

The generating may comprise: forming a first part of the first IP address using information received from a radio access network node, the first part comprising a routable part of the first IP address; and forming a second part of the first IP address that uniquely identifies the user equipment.

The forming the second part of the first IP address may comprise: concatenating at least part of a temporary identifier of the user equipment or a random value with a random value to form a concatenated value; and generating the first IP address from the concatenated value.

The forming the first part of the first IP address may comprise: receiving, from the radio access network node, a network identifier value and a network mask that indicates a length of the first part; and forming the first part by applying the network mask to the network identifier value.

The network identifier value and the network mask may be received via radio resource control configuration signalling.

According to a sixth aspect, there is provided an apparatus for a radio access network node, the apparatus comprising: at least one processor; and at least one memory comprising code that, when executed by the at least one processor, causes the apparatus to perform: signalling, to a user equipment, information for generating a first part of an internet protocol, IP, address for identifying the user equipment for direct non-access stratum signalling between the user equipment and a network function of a core network.

The information may comprise a network identifier value and a network mask that indicates a length of the first part.

The signalling may be comprised in radio resource control configuration signalling.

The apparatus may be caused to perform signalling, to the user equipment in radio resource control configuration signalling, a second IP address, the second IP address identifying a repository function of the core network.

The apparatus may be caused to perform receiving, from the user equipment, an indication of a value used by the user equipment for generating a second part of the first IP address.

The apparatus may be caused to perform: receiving, from the user equipment, non-access stratum signalling for the network function comprised in the core network, the non-access stratum signalling comprising the first IP address; and forwarding the non-access stratum signalling to the network function.

According to a seventh aspect, there is provided an apparatus for a user equipment, the apparatus comprising: identifying circuitry for identifying a first identifier that uniquely identifies the user equipment; and generating circuitry for generating a first internet protocol, IP, address for addressing the user equipment using at least part of the first identifier, the first IP address being for direct non-access stratum signalling between the user equipment and a network function of a core network.

The apparatus may comprise initiating circuitry for, subsequent to said generating, initiating direct non-access stratum signalling the network function using the first IP address.

The apparatus may comprise receiving circuitry for receiving, from a radio access network node, a radio resource control configuration comprising a second IP address, the second IP address identifying a repository function of the core network.

The apparatus may comprise: signalling circuitry for signalling the repository function using the second IP address to request a third IP address that identifies the network function; and receiving circuitry for receiving the third IP address from the repository function.

The apparatus may comprise signalling circuitry for directly signalling the network function using non-access stratum signalling that comprises the third IP address.

The signalling circuitry for signalling the repository function may comprise signalling circuitry for signalling the repository function using radio resource control signalling.

The generating circuitry for generating may comprise: forming circuitry for forming a first part of the first IP address using information received from a radio access network node, the first part comprising a routable part of the first IP address; and forming circuitry for forming a second part of the first IP address that uniquely identifies the user equipment.

The forming circuitry for forming the second part of the first IP address may comprise: concatenating circuitry for concatenating at least part of a temporary identifier of the user equipment or a random value with a random value to form a concatenated value; and generating circuitry for generating the first IP address from the concatenated value.

The forming circuitry for forming the first part of the first IP address may comprise: receiving circuitry for receiving, from the radio access network node, a network identifier value and a network mask that indicates a length of the first part; and forming circuitry for forming the first part by applying the network mask to the network identifier value.

The network identifier value and the network mask may be received via radio resource control configuration signalling.

According to an eighth aspect, there is provided an apparatus for a radio access network node, the apparatus comprising: signalling circuitry for signalling, to a user equipment, information for generating a first part of an internet protocol, IP, address for identifying the user equipment for direct non-access stratum signalling between the user equipment and a network function of a core network.

The information may comprise a network identifier value and a network mask that indicates a length of the first part.

The signalling may be comprised in radio resource control configuration signalling.

The apparatus may comprise signalling circuitry for signalling, to the user equipment in radio resource control configuration signalling, a second IP address, the second IP address identifying a repository function of the core network.

The apparatus may comprise receiving circuitry for receiving, from the user equipment, an indication of a value used by the user equipment for generating a second part of the first IP address.

The apparatus may comprise: receiving circuitry for receiving, from the user equipment, non-access stratum signalling for the network function comprised in the core network, the non-access stratum signalling comprising the first IP address; and forwarding circuitry for forwarding the non-access stratum signalling to the network function.

According to a ninth aspect, there is provided non-transitory computer readable medium comprising program instructions for causing an apparatus for a user equipment to perform: identifying a first identifier that uniquely identifies the user equipment; and generating a first internet protocol, IP, address for addressing the user equipment using at least part of the first identifier, the first IP address being for direct non-access stratum signalling between the user equipment and a network function of a core network.

The apparatus may be caused to perform, subsequent to said generating, initiating direct non-access stratum signalling the network function using the first IP address.

The apparatus may be caused to perform receiving, from a radio access network node, a radio resource control configuration comprising a second IP address, the second IP address identifying a repository function of the core network.

The apparatus may be caused to perform: signalling the repository function using the second IP address to request a third IP address that identifies the network function; and receiving the third IP address from the repository function.

The apparatus may be caused to perform directly signalling the network function using non-access stratum signalling that comprises the third IP address.

The signalling the repository function may comprise signalling the repository function using radio resource control signalling.

The generating may comprise: forming a first part of the first IP address using information received from a radio access network node, the first part comprising a routable part of the first IP address; and forming a second part of the first IP address that uniquely identifies the user equipment.

The forming the second part of the first IP address may comprise: concatenating at least part of a temporary identifier of the user equipment or a random value with a random value to form a concatenated value; and generating the first IP address from the concatenated value.

The forming the first part of the first IP address may comprise: receiving, from the radio access network node, a network identifier value and a network mask that indicates a length of the first part; and forming the first part by applying the network mask to the network identifier value.

The network identifier value and the network mask may be received via radio resource control configuration signalling.

According to a tenth aspect, there is provided non-transitory computer readable medium comprising program instructions for causing an apparatus for a radio access network node to perform: signalling, to a user equipment, information for generating a first part of an internet protocol, IP, address for identifying the user equipment for direct non-access stratum signalling between the user equipment and a network function of a core network.

The information may comprise a network identifier value and a network mask that indicates a length of the first part.

The signalling may be comprised in radio resource control configuration signalling.

The apparatus may be caused to perform signalling, to the user equipment in radio resource control configuration signalling, a second IP address, the second IP address identifying a repository function of the core network.

The apparatus may be caused to perform receiving, from the user equipment, an indication of a value used by the user equipment for generating a second part of the first IP address.

The apparatus may be caused to perform: receiving, from the user equipment, non-access stratum signalling for the network function comprised in the core network, the non-access stratum signalling comprising the first IP address; and forwarding the non-access stratum signalling to the network function.

According to an eleventh aspect, there is provided a computer program product stored on a medium that may cause an apparatus to perform any method as described herein.

According to a twelfth aspect, there is provided an electronic device that may comprise apparatus as described herein.

According to a thirteenth aspect, there is provided a chipset that may comprise an apparatus as described herein.

### BRIEF DESCRIPTION OF FIGURES

Some examples, will now be described, merely by way of illustration only, with reference to the accompanying drawings in which:

FIG. 1 shows a schematic representation of a 5G system;

FIG. 2 shows a schematic representation of a network apparatus;

FIG. 3 shows a schematic representation of a user equipment;

FIGS. 4 and 5 illustrate example signalling paths;

FIGS. 6 and 7 illustrate example signalling; and

FIGS. 8 and 9 illustrate example operations that may be performed by apparatus described herein.

### DETAILED DESCRIPTION

In the following description of examples, certain aspects are explained with reference to devices that are often capable of communication via a wireless cellular system and mobile communication systems serving such mobile communication devices. For brevity and clarity, the following describes such aspects with reference to a 5G and a 6G wireless communication system. However, it is understood that such aspects are not limited to such wireless communication systems, and may, for example, be applied to other wireless communication systems.

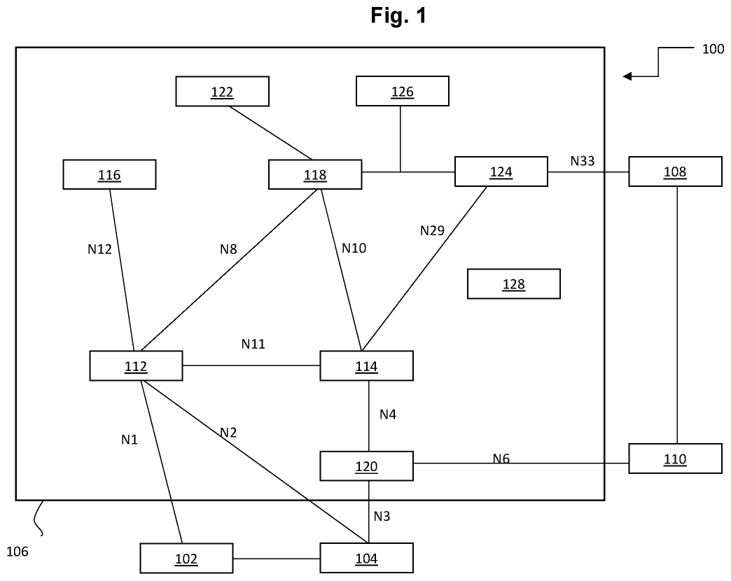

Before describing in detail the examples, certain general principles of a 5G wireless communication system are briefly explained with reference to FIGS. 1 to 3. At least some of these principles and apparatus are also present in a 6G wireless communication system.

FIG. 1 shows a schematic representation of a 5G system (5GS) 100. The 5GS comprises a wireless communication device 102 (which may also be referred to as a UE, communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

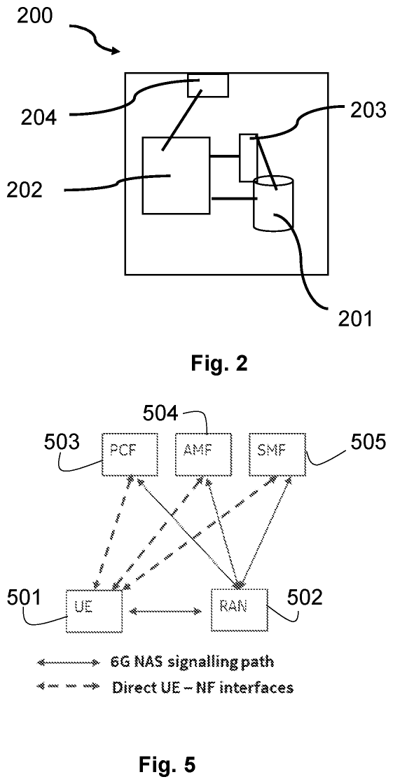

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

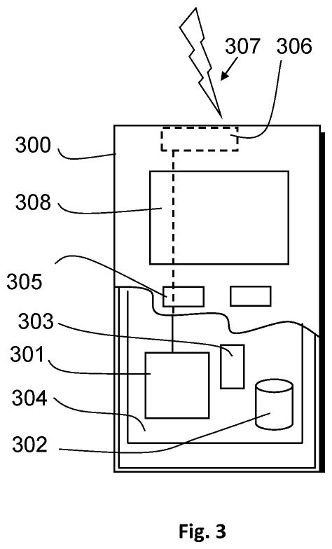

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device may be provided with at least one data processing entity 301, at least one memory 302 and other possible components 303 for use in software and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

Current 5G networks apply non-access stratum (NAS) signalling between terminals (e.g., UE, User Equipment) and an AMF located in a 5G Core Network (CN).

NAS is a functional layer in the New Radio (NR), long-term evolution (LTE), Universal Mobile Telecommunications System (UMTS), and Global System for Mobile Communications (GSM) wireless telecom protocol stacks between the core network and user equipment. This layer is used to manage the establishment of communication sessions and for maintaining continuous communications with the user equipment as the UE moves. Current 5G networks apply non-access stratum (NAS) signalling between terminals and an AMF for performing control plane procedures related to managing UE registration and communications.

All NAS signalling in 5G networks is exchanged between the UE and the AMF over an interface therebetween. The interface between the UE and AMF is also referred to as the “N1” interface, and communications over this interface are passed transparently through access points of the radio access network to the AMF.

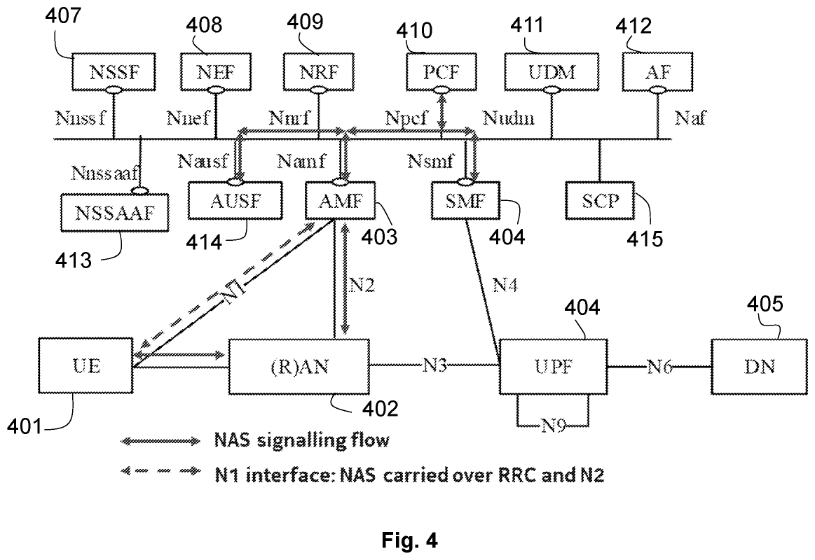

The naming of interfaces between different apparatus and/or functions of a 5G system (including the N1 interface) are illustrated with reference to FIG. 4.

FIG. 4 illustrates a UE 401 that exchanges signalling with at least one element in an access network 402 and with an AMF 403 over an N1 interface. The access network 402 interfaces (e.g., exchanges signalling with) the AMF 403 over an N2 interface, and interfaces with a user plane function 404 over an N3 interface. The user plane function 404 may interface with other user plane functions (not shown) over an N9 interface, with a data network 405 over an N6 interface, and with a session management function 406 over an N4 interface. The CN comprises, in addition to the AMF 403 and SMF 406, a Network Slice Selection Function (NSSF) 407, a network exposure function (NEF) 408, a network repository function (NRF) 409, a policy control function (PCF) 410, a unified data management (UDM) 411, an application function (AF) 412, a Network Slice-Specific Authentication and Authorization Function (NSSAAF) 413, an Authentication Server Function (AUSF) 414, and a Service Communication Proxy (SCP) 415. The respective interfaces from each of the core elements are labelled as Nx in FIG. 4. NAS signalling in current 5G systems is represented by whole arrows in FIG. 4, and N1 signalling is represented by a dashed line in FIG. 4. It is understood that the N1 interface is carrying NAS signalling (with the AMF being the endpoint of this signalling). The arrows merely illustrate that, although N1 is a point to point interface between UE and AMF, in practice the NAS signalling carried by this N1 interface is carried over the radio interface to the AMF (e.g., along the base station—AMF path), before being forwarded to other network functions.

Whenever signalling between the UE and other CN element (e.g., a network function) is needed (e.g., for exchanging session management-related signaling between the UE and an SMF), that signalling is transparently forwarded by the AMF to the respective CN element, over an appropriate service-based interface between the AMF and that CN element. These interfaces are defined in 3GPP.

For example, the radio access network (RAN) connecting the UE to the 5GC comprises a control plane interface (labelled herein as an N2 interface) and a user plane interface (labelled herein as an N3 interface). The N2 interface is used to carry N1 interface signalling from the UE to the AMF via the RAN transparently. In other words, the N2 interface is used such that the base station does not interpret the N1 message comprised thereon, but forwards it to and/or from the AMF over the N2 interface. The N2 interface supports control plane signalling between RAN and 5G core covering scenarios related to UE context management, PDU session/resource management procedures. The N2 interface may use the next generation application protocol (NGAP) between the 5GC and the access network which may be carried by the Stream Control Transmission Protocol (SCTP). On the radio interface (between the UE and a base station of the RAN), NAS signalling is transferred over the RRC (Radio Resource Control) protocol. Therefore, before any NAS signalling can happen, an RRC connection is set up between the UE and the base station.

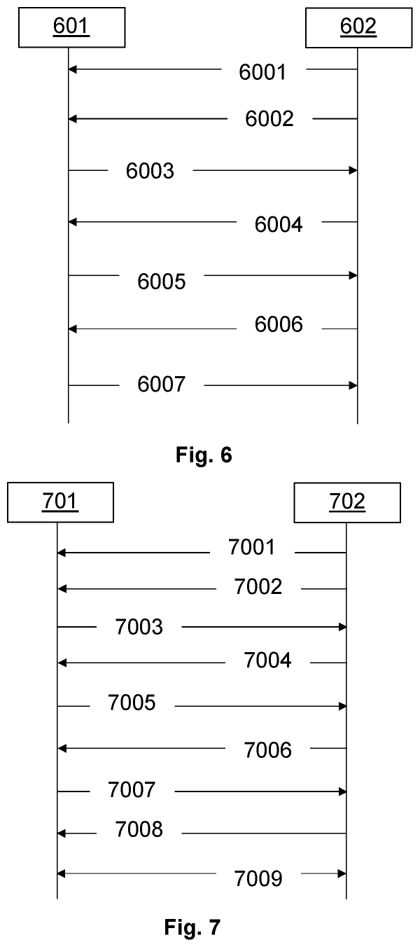

FIG. 6 illustrates example signalling in which a UE 601 exchanges signalling with an access point (e.g., a gNB) 602.

During 6001, after an initial synchronization of the UE with a radio access network, the UE 601 receives a Master Information Block (MIB) from the access point 602. The MIB is a broadcast signal transmitted by access point 602 that comprises physical layer information. This physical layer information may comprise information on a downlink channel bandwidth provided by the access point 602 (e.g., in physical resource blocks), a configuration for a Physical Hybrid Indication Channel (PHICH), and a system frame number for use by the UE 601 for further synchronizing with the access network of the access point 602.

During 6002, the UE 601 receives a System Information Block (e.g., SIB1) from the access point 602. There are currently 13 types of SIBs defined in 3GPP networks (although this value may change). SIB1 comprises information about the cell and network that may assist the UE when the UE is evaluating cell access. SIB1 also comprises information defining the scheduling of other system information blocks. For example, SIB1 may comprise information related to cell selection, cell access, and system information scheduling.

During 6003, the UE 601 signals a random access channel (RACH) preamble to the access point 602 for accessing the core network via the access point 602.

During 6004, the access point 602 responds to the signalling of 6003 with a RACH response. 6003 and 6004 relate to signalling that are performed for synchronizing the UE 601 for making uplink transmissions to the access point 602 within a cell provided by the access point 602.

During 6005, the UE 601 signals a Radio Resource Control (RRC) setup request to the access point 602.

During 6006, the access point 602 signals an RRC setup configuration for the UE 601 to establish an RRC connection between the access point 602 and the UE 601. This signalling may indicate an RRC configuration to be applied by the UE when establishing an uplink communication.

During 6007, the UE 601 signals the access point 602. This signalling may comprise an indication that RRC setup has been completed (e.g., the UE 601 has successfully applied the RRC configuration received during 6006), and request NAS registration to an AMF.

For 6G, the option of service-based NAS signalling is being discussed. Furthermore, an option of direct NAS signalling between the UE and control plane network functions (e.g., such that signalling to the CN elements are not relayed by AMF) is also being considered. Overall, this means adopting some sort of service-based interface paradigm directly between UE and control plane elements of CN. This is illustrated with respect to FIG. 5.

FIG. 5 illustrates an example architecture comprising “direct” UE-Network function interfaces that may be implemented in, for example, a 6G system. In the present application, it is understood that a message passed along the “direct” UE-NF interfaces may pass through other entities than the UE and the NF (such as, for example, a base station) without those other entities interpreting the message. This is different to current 5G signalling in which a forwarding AMF interprets such a message to determine that the message is to be forwarded to the network function. It is understood that the actual “direct” UE-NF interfaces in 6G may comprise alternative interfaces to those depicted in FIG. 5. FIG. 5 shows a UE 501 configured to communicate with a RAN 502 using an NAS signalling path. FIG. 5 further shows a PCF 503, an AMF 504 and an SMF 505. In FIG. 5, the NAS signalling is shown as whole arrows, and the “direct” UE-NF signalling is illustrated by a dashed line.

In current standards (and consequently, in 5G implementations) there is no mechanism directed towards achieving address exchange for a UE to perform NAS signalling with any of plurality of different network functions in a core network.

The present disclosure proposes that direct NAS signalling be performed using IP-based signalling. This means that the UE will have obtained an IP address before sending any NAS messages (that is, even before registration of the UE to the core network). This is in contrast to prior art systems in which NAS is not IP-based, and so the UE does not perform NAS signalling via an IP address.

Furthermore, in the present disclosure, the UE is configured to become aware of respective IP addresses of the corresponding control plane network functions in order to have the necessary control plane services consumed, or direct NAS signalling enabled.

Both concepts relate to the availability of direct UE—control plane network function communication, whereas service-based NAS would also adopt typical service access patterns (e.g. notify, subscribe, etc.) between the UE and control plane network functions.

in other words, to address at least one of the above-mentioned issues, the following proposes to use IP (Internet Protocol) as an addressing method and underlying network protocol for carrying NAS signalling between a UE and a network function (NF) located in a 5GC. In other words, the following proposes using IP-based mechanisms for performing direct UE-NF communication. Standard defined 5G NAS is not based on IP.

In particular, the following proposes mechanisms for obtaining IP addresses for use in such an architecture. It is understood that protocol layers above the IP layer are not relevant to the present discussion, and that any appropriate protocol may be used for signalling at a higher layer. For example, the transport control protocol (TCP) may be used for carrying NAS signalling, and/or the unified datagram protocol (UDP) may be used for carrying NAS signalling, and/or TCP and/or the Hypertext Transfer Protocol (HTTP) carrying a RESTful implementation of NAS may be used.

References are made herein to generating an IP address or an IPv6 address. It is understood that these references and terms are used synonymously throughout. In particular, it is understood that the “IP”, as used herein, refers to any IP-based addressing mechanism that allows autoconfiguration of an IP address. IPv6 currently allows for autoconfiguration of an IP address. IPv4 does not currently allow for autoconfiguration of an IP address.

As an aside, it is noted that every IPv6 network comprises a mask (referred to as a “netmask”) that specifies the number of bits in an IPv6 network address netID part of an IP address, which forms a first part of an IP address. The second part in an IPv6 network address (after the netID) is the HostID. The HostID is also referred to herein as an “interface address”, and a description of how the interface address may be generated is described herein. IPv6 networkmask and IPv6 network (netID) are IETF-defined part of an IPv6 address.

Therefore, in the following, there is provided a UE that generates a unique IP address that identifies the UE for NAS signalling. The unique IP address may comprise a routable prefix/first part that is set by an IP network and which may be common within that IP network. The unique IP address may comprise a second part that is unique to the UE.

In particular, the UE may receive, from a radio access network node, an indication of how to generate a routable prefix part of an IP address that identifies the UE. The UE may use that indication with a unique identifier of the UE to generate an IP address that identifies the UE for NAS signalling purposes. The indication may be received at the UE as part of an initial radio resource control configuration in order that the UE can start NAS signalling even before a PDU session is established for that UE.

To illustrate the principles described herein, the following considers three different factors for enabling service-based direct UE-NF NAS signalling for 3GPP networks.

As a first factor, it will be considered how a UE can obtain an IPv6 address for a UE for NAS signalling of the UE. It is understood that the IPv6 address for use by a UE for NAS signalling of the UE is not an IP address that is used for PDU session communication. The IPv6 address generated according to the presently described mechanisms may be only used for NAS signalling.

This first factor defines a procedure for generating a unique IPv6 address of the UE, using other, standard defined UE identifiers. In particular, at least part of a 5G or 6G UE identifier may be used for generating this unique IPv6 address, although 5G terminology will be used throughout the following description for clarity.

As a second factor, it will be considered how a UE can learn existing respective IPv6 addresses for control plane network functions of the CN for use in NAS signalling.

This second factor relates to using proposed RRC protocol extensions (e.g., as defined in factor 3—see below) to provide core network level information, which enables subsequent NAS signalling over IPv6.

As a third factor, changes to current RRC signalling mechanisms and extensions for 6G RRC signalling mechanisms will be considered for providing the UE within information for generating the UE's unique IP address for NAS signalling, and/or for providing the UE with an identifier of an NRF for discovering (via NAS signalling) other network functions with which the UE may perform NAS signalling.

This third factor relates to defining elements of RRC signalling protocol, including messages and information elements for use by the UE in obtaining at least one of the addresses mentioned above.

These three factors will now be considered in turn.

The first factor is considered.

In order to have IPv6 connectivity for conveying the first NAS signalling message, the following proposes the use of an IPv6 address autoconfiguration method for use by the UE.

IPv6 address autoconfiguration assumes that there is a unique address (e.g., a unique Medium Access Control (MAC) address of the UE. A unique MAC address of the UE does not exist in 3GPP networks (unlike Ethernet and/or WiFi devices). In particular, although the NR MAC procedures use various radio network temporary identifier (RNTI) values that could be seen as some sort of temporary MAC addresses, these RNTI values are not in fact a MAC address. Instead, these RNTIs are temporary and can be different in different cells for the same UE. The RNTIs are, furthermore, not unique to a UE. Protocol Data Unit (PDU) sessions within 3GPP specifications can be associated with a type of Ethernet in which the 3GPP system transports Ethernet frames using a MAC address. However, not all UE devices are capable of setting up such PDU session types of Ethernet.

Therefore, the proposed IPv6 address for NAS signalling with a 3GPP UE is to be generated in a unique way. In particular, the following proposes the use of some other unique UE identifier to be used for this purpose. The other unique UE identifier may be an identifier of the UE that is associated to the UE before or during an RRC setup phase.

In order to enable obtaining IPv6 address that can be used for direct UE-NF signalling, the auto-configured part of the IPv6 address may be prefixed by an IPv6 prefix that is routable in the 3GPP network. Therefore, in this first factor, there is provided a unique UE IP address that comprises a routable prefix (e.g., the NetID part, when combined with the NetID mask) and an autoconfigured part. The autoconfigured part may be referred to as an “interface address”.

There are several different ways of generating the interface address. For example, a unique UE identifier may be provided as an input to an algorithm that is configured to convert that input into a unique IP address. As another example, a unique sequence of any length may have a mask applied to it in order to generate a unique IP address. Each of these options will be considered below.

Example potential unique UE identifiers that may be used to generate the unique IP address comprise the International Mobile Equipment Identity (IMEI) of the UE, the International Mobile Subscriber Identity (IMSI) associated with the UE, and any part of the “InitialUE-Identity” described below in relation to Table 1.

Table 1 illustrates at least some information that may be comprised in an RRC Setup Request Information (such as “InitialUE-Identity” in Table 1, which is generated from a value of “ng-5G-S-TMSI-Part1” and a random value, which is further illustrated below).

TABLE 1
Example Information elements of an RRC setup request message

| | |
|---|---|
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| establishmentCause | EstablishmentCause, |
| spare | BIT STRING (SIZE (1)) |
| } | |
| InitialUE-Identity ::= | CHOICE { |
| ng-5G-S-TMSI-Part1 | BIT STRING (SIZE (39)), |
| randomValue | BIT STRING (SIZE (39)) |
| } | |
| EstablishmentCause ::= | ENUMERATED { |
| | emergency, highPriorityAccess, |
| | mt-Access, mo-Signalling, |
| | mo-Data, mo-VoiceCall, mo-VideoCall, |
| | mo-SMS, mps-PriorityAccess, mcs- |
| | PriorityAccess, |
| | spare6, spare5, spare4, spare3, |
| | spare2, spare1} |

In general, Table 1 illustrates that an RRC setup request comprises an RRC setup request information element (IE) that, in turn, comprises an “InitialUE-Identity” and an “EstablishmentCause”.

The “EstablishmentCause” indicates a reason why the RRC connection is being established. This reason may be, for example, to exchange a certain type of traffic (e.g., data, a voice call, a video call, etc.) and/or to indicate a type of access (e.g., priority and/or emergency signalling).

The InitialUE-Identity field comprises a unique identifier of the UE. As shown in Table 1, the InitialUE-Identity field is defined as comprising:
ng-5G-S-TMSI-Part1: The rightmost 39 bits of 5G-S-TMSI.
randomValue: Integer value in the range 0 to 2\hat{ }39−1.

As an example, at least part of the value of the InitialUE-Identity field may be used for auto-generating the “interface address” part of IPv6 address.

For example, when the UE first ever registers to the network, the UE will not have the 5G-TMSI allocated (and therefore will not have a 5G-S-TMSI allocated either). In this case, in the RRC message the UE may use a random value as “InitialUE-Identity” field of the RRC setup request.

For later registrations of the UE (e.g., after handover of the UE, and/or after expiry of a registration timer run by the UE, and/or after power off/on of the UE, etc.), the UE may use the UE's previously obtained 5G-S-TMSI value as the first 39 bit used as “InitialUE-Identity” in the RRC setup request.

Therefore, when the value of the “InitialUE-Identiy” field is used for generating a unique UE IP address, the value may be at least one of 5G-S-TMSI-Part1 (or, for 6G, an analogous 6G-S-TMSI-Part1) or a random value.

There are a plurality of ways in which a value may be used for generating a unique IP address for the UE. This is discussed in the following, utilizing some of the specific potential values mentioned above. However, it is understood that this is not limiting, and that the same or analogous techniques as those described below may also be performed with resect to other input values.

For example, the UE may concatenate ng-5G-S-TMSI-Part1 (39 bit) with the rightmost 9 bits of randomValue from the InitialUE-Identity for form a 48 bit address. This 48 bit address may be fed into an algorithm (e.g., an Extended Unique Identifier-64 (EUI-64) algorithm) that generates the actual 64 bit long “interface address” part of the IPv6 address of UE as an output of algorithm. EUI-64 is a method used to automatically configure IPv6 host addresses using the MAC address of its interface to generate a unique 64-bit interface identifier. It is understood that any other algorithm that fulfills the same function of creating an IP address from a shorter (or longer) input value may be used. In using this first factor, the routable IPv6 prefix and the mask describing it (see below) may be 64 bits long (see below).

As another example, the UE may use as many bits from the rightmost of InitialUE-Identity directly as the “interface address” part of the IPv6 address as a length of an IPv6 autoconfiguration mask (see below). In this another example, the minimum number of bits to ensure uniqueness of the generated/autoconfigured IPv6 address is 32 (which is the length of the 5G-TMSI).

For the routable prefix part of the IPv6 address, the RRC signalling may be extended with new information elements (IE). These new information elements are respectively indicated below as autoConfigIpv6Net and autoconfigIPv6Netmask.

The features of the second factor (relating to how the UE obtains identifiers/IPv6 addresses for the control plane network function) are now considered.

For this second factor, an IP address of a repository function is first obtained. For example, an equivalent 5G repository function would be the 5G Network Repository Function. Therefore, for clarity in the following, the notation NRF will be used to refer to any repository function, and is not restricted to 5GS.

The IP address of the NRF may then be used to query the IP addresses of other control plane network functions that are to be used as NAS signalling endpoints in any subsequent NAS messaging.

This second mechanism may therefore extend RRC signalling via the provision of a new information element that comprises the IP address of NRF (or equivalent 6G function). The base station may obtain the IP address of the NRF via either being preconfigured with the IP address of the NRF or by performing discovery procedures (e.g., using a domain name system (DNS) lookup).

The third factor, relating to the extensions to existing RRC protocols, will now be described with reference to Table 2.

Table 2 illustrates components of an RRC Setup signalling procedure. The RRC Setup message is illustrated as comprising a set of information elements.

According to previous mechanisms, this set (labelled as “RRCSetup-IEs” in Table 2) comprises a radio bearer configuration information element (radioBearerConfig), a master cell group information element (masterCellGroup) a late non-critical extension information element (lateNonCriticalExtension) and a non-critical extension information element (nonCriticalExtension).

According to presently described mechanisms, the set comprises an sl-ConfigDedicatedNR-r17 information element, an sl-L2RemoteUE-Config-r17 information element, a nonCriticalExtension information element, an autoConfigIpv6Net information element, an autoconfigIPv6Netmask information element, and an NrfIPv6Address information element. The autoConfigIpv6Net information element, autoconfigIPv6Netmask information element, and NrfIPv6Address information element are newly described herein.

Of these newly introduced information elements:
autoConfigIpv6Net: this information element comprises an indication that an IPv6 address network identifier within the UE is to be used by the UE to generate the UE's own unique IPv6 address to start NAS signaling. This information element may comprise the first part of the autoconfigured network address (netID).
autoconfigIPv6Netmask: This information element comprises or otherwise indicates a netmask for use in generating a netID part (e.g., a first part) of an IPv6 address.
NrfIPv6Address: This information element comprises an IPv6 address of Network Repository Function (NRF) for use by the UE for querying the IPv6 addresses of other network functions.

TABLE 2
RRCSetup message description

| | |
|---|---|
| RRCSetup ::= | SEQUENCE { |
| rrc-TransactionIdentifier | RRC-TransactionIdentifier, |
| criticalExtensions | CHOICE { |
| rrcSetup | RRCSetup-IEs, |
| criticalExtensionsFuture | SEQUENCE { } |
| } | |
| } | |
| RRCSetup-IEs ::= | SEQUENCE { |
| radioBearerConfig | RadioBearerConfig, |
| masterCellGroup | OCTET STRING |
| | (CONTAINING |
| lateNonCriticalExtension | CellGroupConfig), |
| nonCriticalExtension | OCTET STRING OPTIONAL |
| | RRCSetup-v1700-IEs |
| } | OPTIONAL |
| RRCSetup-v1700-IEs ::= | SEQUENCE { |
| sl-ConfigDedicatedNR-r17 | SL-ConfigDedicatedNR-r16 |
| | OPTIONAL |
| sl-L2RemoteUE-Config-r17 | SL-L2RemoteUE-Config-r17 |
| | OPTIONAL |
| nonCriticalExtension | SEQUENCE { } OPTIONAL |
| autoConfigIpv6Net | OCTET STRING OPTIONAL |
| autoconfigIPv6Netmask | OCTET STRING OPTIONAL |
| NrfIPv6Address | OCTET STRING OPTIONAL |
| } | |

It is understood that although these new information elements (shown in bold in Table 2) are illustrated as being part of a non-critical extension part originally introduced for sidelink-related messaging, that this is not limiting. These new information elements may be comprised in any appropriate signalling. It is useful for these new information elements to be comprised in non-critical extension signalling (of any form) in order for the signalling to be backwards compatible with prior systems.

After having all the necessary IPv6 information the above-mentioned first to third mechanisms, the UE can progress with the NAS signalling itself. This is illustrated with respect to FIG. 7.

FIG. 7 illustrates example signalling in which a UE 701 exchanges signalling with an access point (e.g., a gNB) 702.

During 7001, the UE 701 receives a Master Information Block from the access point 702. The Master Information Block may be as described above in relation to 7001.

During 7002, the UE 701 receives a System Information Block (e.g., SIB1) from the access point 702. The SIB may be as described as above in relation to 6002.

During 7003, the UE 701 signals a random access channel (RACH) preamble to the access point 702 for accessing the core network via the access point 702.

During 7004, the access point 702 responds to the signalling of 7003 with a RACH response. 7003 to 7004 may comprise the signalling described above inr elation to 6003 to 6004.

During 7005, the UE 701 signals a Radio Resource Control (RRC) setup request to the access point 702.

During 7006, the access point 702 signals an RRC setup configuration for the UE 701 to establish an RRC connection between the access point 702 and the UE 701. In addition to the information described above in 6006, the signalling of 7006 may comprise an NRF IPv6 address (i.e., an IPv6 address for the NRF), an IPv6 Network Mask, and an IPv6 Network. As referred to above, IPv6 networkmask and IPv6 network (netID) are IETF-defined part of an IPv6 address. IPv6 network comprises the first part of the autoconfigured network address (netID). The IPv6 network mask is all binary 1s with the length of the IPv6 network address. The IPv6 network mask is the same as netID in IETF-defined IPv6 address.

During 7007, the UE 701 signals the access point 702. This signalling may comprise an indication that RRC setup has been completed. The signalling of 7007 may request a first NAS service IP address for identifying the UE to network functions within the core network when NAS signalling is used. In other words, unlike in current 5G systems, in which this RRC setup signalling comprises a “registration request” NAS message that is forwarded to the AMF, the present signalling may not comprise such a “registration request” NAS message. Instead, the signalling of 7007 queries the IP address of the first network function and/or network service to be contacted by the UE.

During 7008, the access point 702 signals the UE 701. This signalling of 7008 may comprise an IP address of Service for use by the UE. This IP address of Service may be an IP address of a network function for providing the service to the UE 701.

During 7009, the UE 701 and the access point 702 exchange NAS messaging using the IP address of Service. As previously mentioned, the IP addresses for the network function(s) that perform NAS signalling with the UE 701 may be obtained by the UE 701 querying the NRF for this information (using the NRF IPv6 address). This signalling may comprise a “Get NAS Service IP address” request.

Therefore, in the signalling example of FIG. 7, a UE obtains an NRF IP address prior to sending a first NAS signaling message during 7007. During this signalling of 7007, the UE may send a query to the NRF as a first NAS signalling message, where the endpoint IP address of the endpoint of the first NAS signalling message is obtained.

For all the subsequent NAS messages, the UE requests at least one IPv6 address of any subsequent NAS message endpoint (denoted as Get NAS Service IP address in 7009). Subsequent to obtaining an NAS message endpoint for at least one network function during 7009, the UE may use that NAS message endpoint as an address for performing NAS signalling with that network function.

Therefore, in the present example, during 7008, the access point 702 may provide the UE 701 with an IP address for an NRF. Subsequently, during 7009, the UE 701 may use the provided NRF's IP address to signal at least one query to the NRF for discovering the IP address of at least one other network function for providing a service to the UE. The discovered IP address(es) may be used by the UE to perform NAS signalling with the network function(s) associated with the discovered address(es).

It is understood that although the example of FIG. 7 comprises correspondences with the 5G procedure of FIG. 6 (e.g., where the request for an NAS address using the NRF IP address is sent along with the RRC setup complete), this specific form of signalling is not limiting.

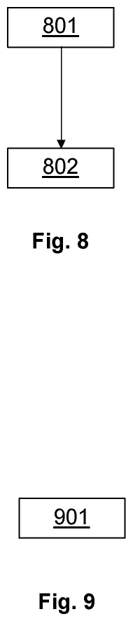

FIGS. 8 and 9 illustrate example operations that may be performed by apparatus implemented the principles described herein. It is therefore understood that features mentioned below may find correspondence with features described in the above examples. Moreover, features mentioned above may provide examples of how the presently described principles may be implemented in some systems.

In the examples of FIGS. 8 and 9 refer to IP addresses. These IP addresses may be IP addresses compliant with an IP addressing protocol that allows for autoconfiguration of IP addresses. For example, these IP addresses may be IPv6 addresses.

FIG. 8 illustrates operations that may be performed by a user equipment.

During 801, the user equipment identifies a first identifier that uniquely identifies the user equipment. The first identifier may be, for example, an IMEI of the UE, an IMSI associated with the UE, and any part of the “InitialUE-Identity” described above in relation to Table 1 (e.g., a random value and/or a ng-5G-S-TMSI-Part1).

During 802, the user equipment generates a first internet protocol, IP, address for addressing the user equipment using at least part of the first identifier, the first IP address being for direct non-access stratum signalling between the user equipment and a network function of a core network.

The generating the first IP address may comprise: forming a first part of the first IP address using information received from a radio access network node, the first part comprising a routable part of the first IP address; and forming a second part of the first IP address that uniquely identifies the user equipment. The user equipment may form the second part of the first IP address by: concatenating at least part of a temporary identifier of the user equipment or a random value with a random value to form a concatenated value; and generating the first IP address from the concatenated value. The random value may be a random value assigned to the user equipment during a registration of the user equipment to the network via the radio access network node (e.g., the random value comprised in InitialUE-Identity). The temporary identifier may be a temporary identifier used by the radio access network to identify the user equipment. For example, the temporary identifier may comprise the ng-5G-S-TMSI-Part1 identifier comprised in InitialUE-Identity.

The forming the first part of the first IP address may comprise: receiving, from the radio access network node, a network identifier value and a network mask that indicates a length of the first part; and forming the first part by applying the network mask to the network identifier value. The network identifier value and the network mask may be received via radio resource control configuration signalling.

Subsequent to said generating, the user equipment may initiate direct non-access stratum signalling the network function using the first IP address.

The user equipment may receive, from a radio access network node, a radio resource control configuration comprising a second IP address, the second IP address identifying a repository function of the core network (e.g., an NRF of a 3GPP (e.g., 6G) network). The user equipment may signal the repository function using the second IP address to request a third IP address that identifies the network function, and receive the third IP address from the repository function. This signalling to the repository function may comprise the first IP address. The signalling to the repository function may comprise NAS signalling using an IP-based protocol. The signalling the repository function may comprise signalling the repository function using radio resource control signalling.

The user equipment may directly signal the network function using non-access stratum signalling that comprises the third IP address. This signalling to the network function may comprise the first IP address. The signalling to the network function may comprise NAS signalling using an IP-based protocol.

FIG. 9 illustrates operations that may be performed by a radio access network node. The radio access network node may be the radio access network node mentioned above in relation to FIG. 8.

During 901, the radio access network node signals, to a user equipment, information for generating a first part of an internet protocol, IP, address for identifying the user equipment for direct non-access stratum signalling between the user equipment and a network function of a core network. The user equipment may be the user equipment described above in relation to FIG. 8.

The information may comprise a network identifier value and a network mask that indicates a length of the first part.

The signalling may be comprised in radio resource control configuration signalling.

The radio access network node may signal, to the user equipment in radio resource control configuration signalling, a second IP address, the second IP address identifying a repository function of the core network.

The radio access network node may receive, from the user equipment, an indication of a value used by the user equipment for generating a second part of the first IP address.

The radio access network node may: receive, from the user equipment, non-access stratum signalling for the network function comprised in the core network, the non-access stratum signalling comprising the first IP address; and forward the non-access stratum signalling to the network function.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 8 and/or FIG. 9, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

1. A method for a user equipment, the method comprising:
identifying a first identifier that uniquely identifies the user equipment;
generating a first internet protocol, IP, address for addressing the user equipment using at least part of the first identifier, the first IP address being for direct non-access stratum signalling between the user equipment and a network function of a core network; and
subsequent to said generating, initiating direct non-access stratum signalling with the network function using the first IP address.

2. A method as claimed in claim 1, the method further comprising
receiving, from a radio access network node, a radio resource control configuration comprising a second IP address, the second IP address identifying a repository function of the core network;
signalling the repository function using the second IP address to request a third IP address that identifies the network function; and
receiving the third IP address from the repository function; and
directly signalling the network function using non-access stratum signalling that comprises the third IP address.

3. A method as claimed in claim 2, wherein the signalling the repository function comprises signalling the repository function using radio resource control signalling.

4. A method as claimed in claim 1, wherein the generating comprises:
forming a first part of the first IP address using information received from a radio access network node, the first part comprising a routable part of the first IP address; and
forming a second part of the first IP address that uniquely identifies the user equipment.

5. A method as claimed in claim 4, wherein at least one of the following:
the forming the second part of the first IP address comprises:
concatenating at least part of a temporary identifier of the user equipment or a random value with a random value to form a concatenated value, and generating the first IP address from the concatenated value; or
the forming the first part of the first IP address comprises:
receiving, from the radio access network node, a network identifier value and a network mask that indicates a length of the first part, and forming the first part by applying the network mask to the network identifier value.

6. A method as claimed in claim 5, wherein the network identifier value and the network mask are received via radio resource control configuration signalling.

7. A method for a radio access network node, the method comprising:
signalling, to a user equipment, information for generating a first part of an internet protocol, IP, address for identifying the user equipment for direct non-access stratum signalling between the user equipment and a network function of a core network,
wherein the information comprises a network identifier value and a network mask that indicates a length of the first part.

8. A method as claimed in claim 7, wherein the signalling is comprised in radio resource control configuration signalling.

9. A method as claimed in claim 7, the method further comprising signalling, to the user equipment in radio resource control configuration signalling, a second IP address, the second IP address identifying a repository function of the core network.

10. A method as claimed in claim 7, the method further comprising receiving, from the user equipment, an indication of a value used by the user equipment for generating a second part of the first IP address.

11. An apparatus for a user equipment, the apparatus comprising:
at least one processor; and
at least one memory storing instructions which, when executed by the at least one processor, cause the apparatus at least to perform:
identifying a first identifier that uniquely identifies the user equipment;
generating a first internet protocol, IP, address for addressing the user equipment using at least part of the first identifier, the first IP address being for direct non-access stratum signalling between the user equipment and a network function of a core network; and
initiating, subsequent to said generating, direct non-access stratum signalling with the network function using the first IP address.

12. An apparatus as claimed in claim 11, wherein the instructions are further configured to, when executed by the at least processor, cause the apparatus to perform:
receiving, from a radio access network node, a radio resource control configuration comprising a second IP address, the second IP address identifying a repository function of the core network;
signalling the repository function using the second IP address to request a third IP address that identifies the network function;
receiving the third IP address from the repository function; and
directly signalling the network function using non-access stratum signalling that comprises the third IP address.

13. An apparatus as claimed in claim 12, wherein the instructions are further configured to, when executed by the at least one processor, cause the apparatus to perform signalling the repository function using radio resource control signalling.

14. An apparatus as claimed in claim 11, wherein the instructions are further configured to, when executed by the at least one processor, cause the apparatus to perform:
forming a first part of the first IP address using information received from a radio access network node, the first part comprising a routable part of the first IP address; and
forming a second part of the first IP address that uniquely identifies the user equipment.

15. An apparatus as claimed in claim 14, wherein the instructions are further configured to, when executed by the at least one processor, cause the apparatus to perform at least one of the following:
concatenating at least part of a temporary identifier of the user equipment or a random value with a random value to form a concatenated value, and generating the first IP address from the concatenated value; or
receiving, from the radio access network node, a network identifier value and a network mask that indicates a length of the first part, and forming the first part by applying the network mask to the network identifier value.

16. An apparatus as claimed in claim 15, wherein the network identifier value and the network mask are received via radio resource control configuration signalling.

17. An apparatus for a radio access network node, the apparatus comprising:
at least one processor; and
at least one memory storing instructions which, when executed by the at least one processor, cause the apparatus at least to perform:
signalling, to a user equipment, information for generating a first part of an internet protocol, IP, address for identifying the user equipment for direct non-access stratum signalling between the user equipment and a network function of a core network, wherein the information comprises a network identifier value and a network mask that indicates a length of the first part.

18. An apparatus as claimed in claim 17, wherein the signalling is comprised in radio resource control configuration signalling.

19. An apparatus as claimed in claim 17, wherein the instructions are further configured to, when executed by the at least one processor, cause the apparatus to perform signalling, to the user equipment in radio resource control configuration signalling, a second IP address, the second IP address identifying a repository function of the core network.

20. An apparatus as claimed in claim 17, wherein the instructions are further configured to, when executed by the at least one processor, cause the apparatus to perform receiving, from the user equipment, an indication of a value used by the user equipment for generating a second part of the first IP address.
